(19) United States
(12) Patent Application Publication
(10) Pub. No.: US 2022/0124880 A1
(43) Pub. Date: Apr. 21, 2022

(54) HEATING COOKER

(71) Applicant: Panasonic Intellectual Property Management Co., Ltd., Osaka (JP)

(72) Inventors: Hirofumi KOMOTO, Hyogo (JP); Kyohei YABUNO, Hyogo (JP); Yuji YAMAMOTO, Hyogo (JP); Masashi KINOSHITA, Hyogo (JP)

(21) Appl. No.: 17/270,140

(22) PCT Filed: Jul. 16, 2020
(86) PCT No.: PCT/JP2020/027647

§ 371 Date: Feb. 22, 2021

(30) Foreign Application Priority Data
Dec. 16, 2019 (JP) 2019-226597

(51) Int. Cl. H05B 6/06

(52) U.S. Cl. CPC H05B 6/062; H05B 2213/07

(57) ABSTRACT

The present disclosure provides a heating cooker with improved usability. A heating cooker comprising: a heating unit that heats a cooking object; a temperature detector that detects temperature information about the cooking object; a controller that controls the heating unit based on heating conditions including at least a heating temperature and a heating time, and the temperature information; and a communicator that communicates with an external device, wherein the external device receives input information from a user, wherein the communicator transmits the input information received from the external device to the controller, and wherein the controller creates, when the input information is predetermined input information, update information about at least the heating temperature among the heating conditions based on the predetermined input information.

### TECHNICAL FIELD

The present disclosure relates to a heating cooker.

### BACKGROUND ART

There is known a heating cooker that can update the cooking time by communicating with an external device. For example, in the cooking device described in Patent Document 1, a user operates an external device to send the information to the cooking device, and controls the cooking time to perform heating cooking. Also, in recent years, a cooking device not only updating the cooking time but also controlling the heating power and the cooking time by an external terminal to update the cooking menu is also being studied.

### PRIOR ART DOCUMENT

### Patent Document

Patent Document 1: JP 2014-164837 A

### SUMMARY OF THE INVENTION

### Problems to be Solved by the Invention

There is still room for improvement in the conventional cooking device in terms of improving usability.

Therefore, it is an object of the present disclosure to provide a heating cooker with improved usability.

### Means for Solving the Problems

A heating cooker according to an aspect of the present disclosure includes a heating unit that heats a cooking object, a temperature detector that detects temperature information about the cooking object, a controller that controls the heating unit based on heating conditions including at least a heating temperature and a heating time, and the temperature information, and a communicator that communicates with an external device, wherein the external device receives input information from a user, the communicator transmits the input information received from the external device to the controller and the controller creates, when the input information is predetermined input information, update information about at least the heating temperature among the heating conditions based on the predetermined input information.

### Effects of the Invention

According to the present disclosure, it is possible to provide a heating cooker with improved usability.

### BRIEF DESCRIPTION OF THE DRAWINGS

FIG. 1 is a perspective view showing an example of the heating cooker of the present disclosure.

FIG. 2 is a schematic configuration diagram of the heating cooker of FIG. 1.

FIG. 3 is a diagram showing an example of an operation screen of an external device communicating with the heating cooker of FIG. 1.

FIG. 4 is a flowchart showing an example of a cooking operation according to the first embodiment of the heating cooker of FIG. 1.

FIG. 5 is a flowchart showing an example of a cooking operation according to the second embodiment of the heating cooker of FIG. 1.

FIG. 6 is a flowchart showing an example of a cooking operation according to the third embodiment of the heating cooker of FIG. 1.

FIG. 7A is a diagram showing the cooking result of Comparative Example 1.

FIG. 7B is a diagram showing the cooking result of Example 1.

### MODES FOR CARRYING OUT THE INVENTION

### Background to this Disclosure

A heating cooker having an automatic cooking function that automatically cooks an object to be cooked according to a preset heating condition is known. The automatic cooking function includes for example, a function of cooking an object to be cooked by automatically adjusting the heating condition such as heating time or heating power according to a selected menu. Also, in recent years, a communication module is installed in the heating cooker, and the heating cooker communicates with an external device such as a smartphone, so that it is possible to select a menu, a cooking mode, etc. from the external device.

In conventional cooking device, automatic cooking is performed based on the heating conditions such as a preset cooking time and a preset heating power. The heating power is the output of the cooking device when heating. It is also possible for the user to customize these heating conditions to change the heating conditions for automatic cooking.

However, the present inventors have recognized that the temperature of the cooking object actually rises gradually even when the heating power is constant especially when the heating power among the heating conditions is set, and it is difficult to obtain the desired cooking results.

In a case where the user tries to customize the heating condition when the heating condition include a heating power setting, the heating power or the heating time will be changed. For example, when customizing the condition to extend the heating time in order to be closer to the desired cooking result, the temperature will rise too much when the heating power setting is left as it is, and the object to be cooked may be overheated. As a result, it is necessary to customize the heating condition many times until a desired cooking result is obtained, which poses a problem in terms of user convenience.

The present inventors have found that when the user customizes the heating condition, the desired cooking result can be easily obtained by inputting the heating temperature or the information associated with the heating temperature instead of inputting the heating power.

Therefore, the present inventors have studied setting a heating temperature instead of the heating power as a heating condition.

The present inventors have adopted a heating temperature as a heating condition, and furthermore, devised a heating cooker that allows the user to customize the heating condition to make the following invention.

A heating cooker according to an aspect of the present disclosure includes a heating unit that heats a cooking object, a temperature detector that detects temperature information about the cooking object, a controller that controls the heating unit based on heating conditions including at least a heating temperature and a heating time, and the temperature information, and a communicator that communicates with an external device, wherein the external device receives input information from a user, the communicator transmits the input information received from the external device to the controller and the controller creates, when the input information is predetermined input information, update information about at least the heating temperature among the heating conditions based on the predetermined input information.

According to this configuration, it is possible to provide a heating cooker with improved usability.

The external device may receive the input information after cooking is completed, and the controller may change the heating conditions based on the update information.

According to this configuration, the user can enter the input information based on the cooking result to reflect the cooking result in the update information.

The input information may be the cooking result of the cooking object.

According to this configuration, it is possible to create update information about the heating condition so as to be closer to the cooking result desired by the user by using the cooking result as input information.

The input information may be a cooking mode.

According to this configuration, it is possible to create update information about heating condition corresponding to each cooking mode.

The controller further may include a learning unit that accumulates the input information and corrects the update information based on the accumulated input information, and the controller may change the heating conditions based on the update information corrected by the learning unit.

According to this configuration, each time the user performs cooking using the heating cooker, the heating condition is automatically updated to be closer to the cooking result desired by the user, so that the usability can be further improved.

The external device may receive the input information during and/or after performing cooking, and the controller may create the update information about the heating temperature and the heating time among the heating conditions.

According to this configuration, since the input information is received even during the execution of cooking, the heating condition for the current cooking can be changed. Further, when the input information is received after the cooking is completed, the heating condition for the next cooking can be changed. As a result, the cooking result desired by the user can be easily obtained.

The input information may include information about the heating time.

According to this configuration, for example, the heating time of the current cooking can be shortened or extended, and the usability can be further improved.

Before performing cooking, the controller may create cooking guidance information presented to a user based on the update information when performing cooking last time.

According to this configuration, since the update information about the heating condition is presented before the cooking is performed, the user can change the heating condition before performing the cooking. Therefore, user convenience is further improved.

A presentation unit that presents the guidance information may be further included.

According to this configuration, the user can acquire cooking guidance information.

Hereinafter, embodiments will be described with reference to the drawings.

### First Embodiment

[Overall Structure]

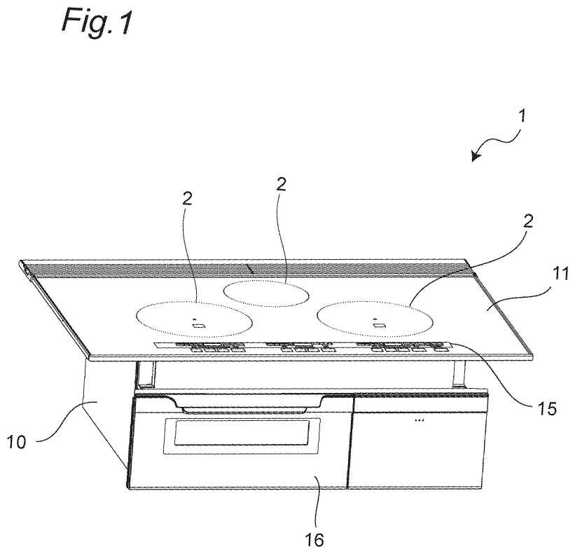

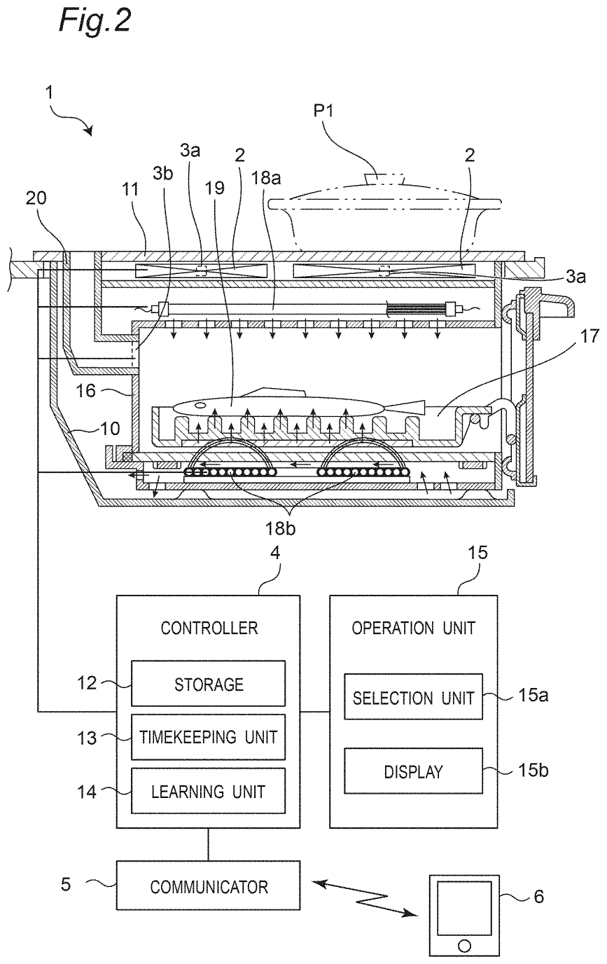

FIG. 1 is a diagram showing an example of a heating cooker 1 according to the first embodiment of the present disclosure. FIG. 2 is a schematic configuration diagram showing an outline of the heating cooker 1 of FIG. 1.

For convenience of explanation, terms such as “up”, “down”, “front”, and “rear” are used assuming a state during normal use. However, these terms do not mean to limit the usage state and the like of the heating cooker 1 of the present embodiment.

As shown in FIGS. 1 and 2, the heating cooker 1 has three heating units 2, three temperature detectors 3a, a controller 4, and a communicator 5. In the present embodiment, the heating cooker 1 is an induction heating cooker. Further, the heating cooker 1 has a main body 10, and a top plate 11 is disposed on the upper face of the main body 10. For example, a cooking utensil P1 shown in FIG. 2 is placed on the top plate 11, and the cooking utensil P1 is heated by the heating unit 2. The cooking utensil P1 is, for example, a utensil that food materials can be put inside such as a pot or a frying pan. The cooking utensil P1 corresponds to a “cooking object” of the present disclosure.

As shown in FIG. 2, the heating cooker 1 has a grill inside the main body 10. The grill may have a cooking chamber 16, a cooking plate 17, and heaters 18a and 18b. A food material 19 can be placed on the cooking plate 17.

The heating unit 2 has a heating coil and heats the cooking utensil P1 by an induction heating method. The heating unit 2 is controlled by the controller 4 to inductively heat the cooking utensil P1.

The temperature detector 3a is disposed in the heating coil under the top plate 11 and detects temperature information about the cooking utensil P1. The temperature information about the cooking utensil P1 is, for example, the bottom face temperature of the cooking utensil P1. A sensor capable of detecting temperature, such as a thermistor or an infrared sensor, can be adopted as the temperature detector 3a.

As shown in FIG. 2, the controller 4 includes a storage 12, a timekeeping unit 13, and a learning unit 14. The controller 4 includes a general-purpose processor such as a CPU or an MPU that realizes a predetermined function by executing a program stored in the storage 12 such as a memory. The controller 4 is configured by, for example, a microcomputer.

The storage 12 stores a cooking menu, a cooking mode, and a heating condition corresponding to the cooking menu and the cooking mode, which will be described later. The controller 4 selects the corresponding heating condition based on the cooking menu and the cooking mode selected by the user, and controls the heating unit 2.

The heating conditions include at least the heating temperature and the heating time. Further, the controller 4 adjusts the output of the heating unit 2, that is, the heating power, during heating in order to keep the heating temperature at a preset temperature.

Further, the controller 4 is connected to an operation unit 15. The operation unit 15 includes a selection unit 15a and a display 15b, and makes various settings of the heating cooker 1. By a user operating the selection unit 15a, the cooking menu and the cooking mode described later can be selected. The cooking menu and the cooking mode selected by the user can be displayed on the display 15b. In the present embodiment, as shown in FIG. 1, the operation unit 15 is disposed on the top plate 11. The display 15b corresponds to a “presentation unit” of the present disclosure.

As shown in FIG. 2, the communicator 5 is connected to the controller 4 and can communicate with the external device 6. In the present embodiment, the communicator 5 and the external device 6 can communicate with each other by a wireless LAN.

The external device 6 may be, for example, a smartphone, a tablet terminal, an electronic device such as a PC, or a dedicated terminal compatible with the heating cooker 1, and may be possible to connect to the Internet.

An application that manages information transmitted and received during communication with the controller 4 is installed in the external device 6. With this application, for example, control information that controls the heating cooker 1 can be checked. Also, when the external device 6 can be connected to the Internet, it is also possible to acquire control information and the like of the heating cooker 1 via the Internet.

The control information is, for example, information such as a recipe corresponding to the heating cooker 1 or a cooking menu, a cooking mode, and a heating condition described later. In addition, when the user operates the application installed on the external device 6, it may be configured to be able to transmit an operation instruction to the heating cooker 1, for example, an instruction of turning on/off the power supply of the heating cooker 1 or an instruction of starting/ending heating.

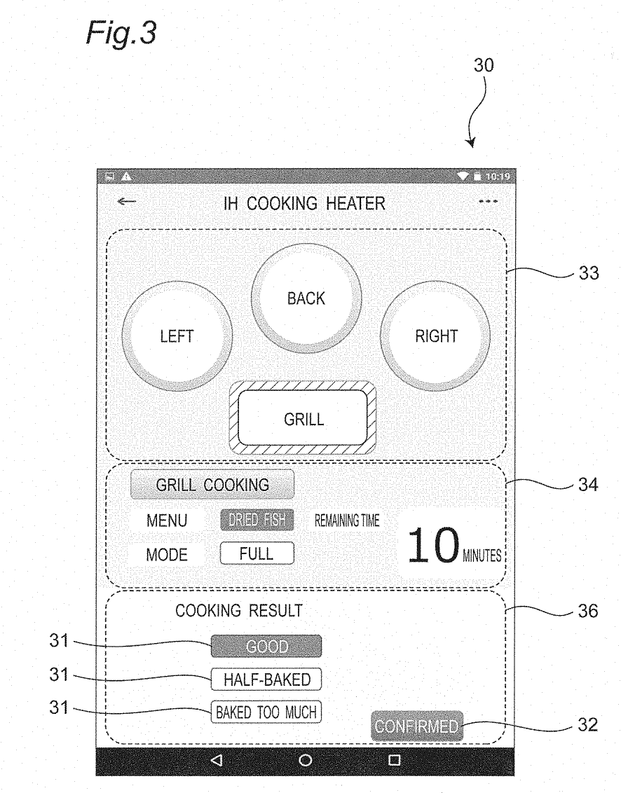

FIG. 3 is a diagram showing an example of an operation screen of an external device connected to the heating cooker 1 of FIG. 1.

As shown in FIG. 3, an operation screen 30 of the external device displays information about the cooking currently being performed. The operation screen 30 includes a heating display 33, a menu display 34, and a cooking result display 35.

Of the three heating units 2 and the cooking chamber 16, the heating display 33 highlights the one which is being heated (during cooking). In the embodiment, since the heating cooker 1 has the three heating units 2 and the cooking chamber 16 (grill), the three heating units 2 are represented by “left”, “back”, and “right”, and the cooking chamber 16 is represented by “Grill”. In the example of FIG. 3, since the grill is being used for heating, the display is such that it is possible to know that heating is performed at the grill. The display method is not limited to this.

The menu display 34 displays the selected cooking menu, the cooking mode, and remaining cooking time. In the example of FIG. 3, the cooking menu “DRIED FISH” and the cooking mode “FULL” are selected for the grill. Further, in the example of FIG. 3, the menu display 34 also displays that the remaining cooking time is 10 minutes.

The cooking result display 35 displays a cooking result button 31 and a confirmation button 32. The cooking result is, for example, the finished state of the cooked product or the evaluation of the cooked product. Alternatively, the cooking result may be, for example, the state or evaluation of the cooking operation. The cooking result button 31 to select a cooking result for the cooking currently being performed is disposed on the cooking result display 35. In the embodiment, there are three types of buttons: “GOOD”, “HALF-BAKED”, and “BAKED TOO MUCH”. “GOOD” is selected, for example, when the cooking result desired by the user is obtained. “HALF-BAKED” is selected, for example, when the heating temperature or heating time is insufficient. “BAKED TOO MUCH” is selected when the heating temperature or heating time is too much. By selecting one of them and pressing the confirmation button 32, the cooking result is transmitted to the heating cooker 1. The display contents of the cooking result button 31 may differ depending on the cooking menu described later. For example, the displayed cooking result may be a state or an evaluation of a cooking operation such as “GOOD, SLOW”. The operation screen 30 is an example, and the application of the external device 6 may be provided with a plurality of screens other than the operation screen 30.

<Cooking Menu>

The heating cooker 1 has a plurality of cooking menus, and automatically heats the cooking object according to the cooking menu selected by the user. Here, “automatically heating the cooking object” means automatically adjusting the heating power to keep the preset heating temperature constant for the preset heating time depending on the cooking menu. In addition, in this specification, “automatically heating the cooking object” may be referred to as automatic cooking.

The cooking menu is, for example, the name of the cooking method or the cooking object. The cooking menu includes, for example, “BAKE”, “STEW”, “FRY”, “STEAM”, “BOIL”, “RICE COOKING”, “WATER HEATING”, and the like. In addition, each menu may include submenus. For example, the “BAKE” menu may include submenus such as “HOT CAKE”, “HAMBURGER”, and “JIAOZI”.

For example, when the “HAMBURGER” submenu of the “BAKE” menu is selected, cooking is carried out according to a preset heating temperature and a preset heating time, for example, (1) Preheat to 200° C., (2) Bake at 200° C. for 3 minutes, (3) Bake at 180° C. for 2 minutes, and (4) Bake at 200° C. for 3 minutes. The heating conditions are the preset heating temperature and the preset heating time. The heating condition corresponding to the combination of the cooking menu and the cooking mode described later is set in advance.

For example, when step (1) is completed, a guidance by voice or display instructing the user to put the food material (hamburger) in the cooking utensil P1 (frying pan) is output. When the user puts the food material and operates the application of the external device 6 or the selection unit 15a of the operation unit 15, step (2) is started. When step (2) is started, the heating time is measured by the timekeeping unit 13 of the controller 4, and when the preset heating time elapses, step (2) ends. When step (2) is completed, a guidance instructing the user to turn over the food material (hamburger) is output. Similarly, in step (3) and step (4), the controller 4 controls the heating temperature and the heating time.

The above example is an example of a cooking menu when performing cooking using the heating unit 2. When using the cooking chamber 16, a cooking menu different from the above may be prepared.

<Cooking Mode>

A cooking mode can be selected for each cooking menu. The cooking mode is, for example, a mode of cooking operation desired by the user, or a state of finishing the cooking object desired by the user. The cooking modes include, for example, “FULL”, “QUICK”, “STANDARD”, and the like. In the cooking mode, the “FULL” mode can be selected when it is desired to perform heating more than “STANDARD” mode by, for example, raising the heating temperature or lengthening the heating time, based on “STANDARD”. When it is desired to shorten the heating time (cooking time), it is possible to select the “QUICK” mode.

For example, when the example of the heating condition of the above-mentioned “HAMBURGER” is supposed to be the “STANDARD” mode, in the “FULL” mode, the heating condition of (3) may be set to a heating temperature of 180° C. and a heating time of 4 minutes. Similarly, in the “QUICK” mode, the heating condition may be set to (1) a preheating temperature of 210° C., (2) a heating temperature of 210° C., and a heating time of 2 minutes, (3) a heating temperature of 190° C., and a heating time of 1 minute, and (4) a heating temperature of 210° C., and a heating time of 2 minutes. In this way, the cooking mode allows a plurality of heating conditions to be associated with the same cooking menu. In addition, the cooking mode may be a finish state of a cooking object, such as “WELL-DONE”, “MEDIUM”, or “RARE”. The above-mentioned cooking menu, cooking mode, heating temperature, and heating time are examples, and the present invention is not limited thereto.

<Heating Condition>

The preset heating temperature and the preset heating time when the cooking menu and the cooking mode are selected correspond to “heating conditions” of the present disclosure. The heating conditions may include at least the heating temperature and the heating time.

[Operation]

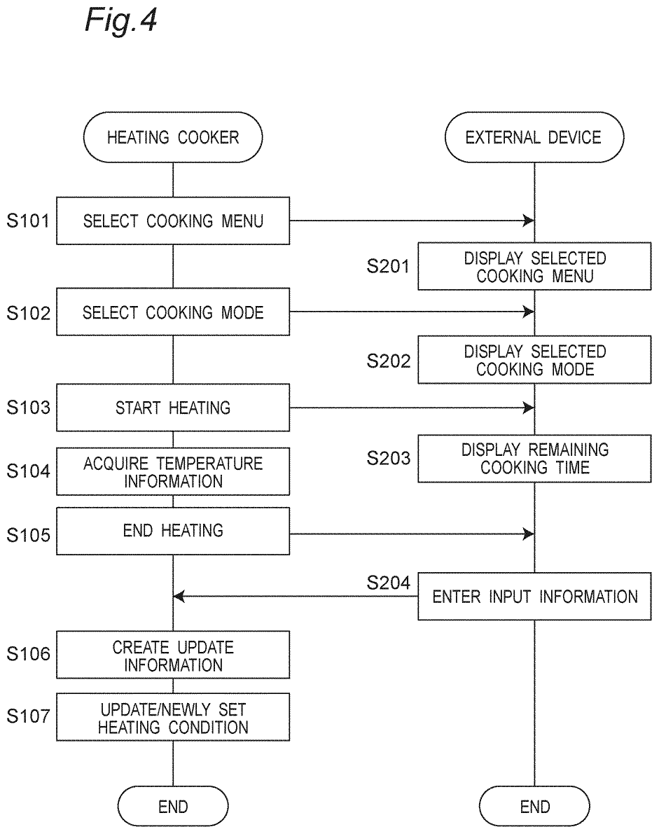

FIG. 4 is a flowchart showing an example of automatic cooking of the heating cooker 1. The operation of automatic cooking of the heating cooker 1 will be described with reference to FIG. 4.

The cooking menu is selected by the user operating the selection unit 15a of the operation unit 15 of the heating cooker 1 (step S101). When the user selects the cooking menu, the information about the selected cooking menu is transmitted from the controller 4 to the external device 6 via the communicator 5. As a result, the selected cooking menu is displayed in the application installed on the external device 6 (step S201). The user may operate the application of the external device 6 to select the menu, or the selected menu may be displayed on the display 15b of the operation unit 15 of the heating cooker 1.

The cooking mode is selected by the user operating the selection unit 15a of the operation unit 15 of the heating cooker 1 (step S102). When the user selects the cooking mode, the information about the selected cooking mode is transmitted from the controller 4 to the external device 6 via the communicator 5. As a result, when the user selects the cooking mode, the selected cooking mode is displayed in the application installed on the external device 6 (step S202).

When the cooking menu and the cooking mode are selected, the controller 4 starts heating (step S103). When heating is started, and the information that the heating has started is transmitted from the controller 4 to the external device 6 via the communicator 5, the remaining cooking time is displayed in the application installed on the external device 6 (step S203).

The remaining cooking time is determined based on the heating time preset for the selected cooking menu and the selected cooking mode, and the time from the heating start measured by the timekeeping unit 13 of the controller 4.

The external device 6 may display the remaining cooking time based on the preset heating time and, for example, the time of the clock built into the external device 6. Alternatively, information about the remaining cooking time may be received from the controller 4 of the heating cooker 1 at appropriate intervals. The remaining cooking time may be similarly displayed on the display 15b of the heating cooker 1.

When heating is started, in the heating cooker 1, the temperature information about the cooking object is acquired by measuring the bottom face temperature of the cooking utensil P1 using the temperature detector 3a (step S104). When the acquired temperature information is different from the preset heating temperature, the controller 4 adjusts the heating power of the heating unit 2 so that the temperature of the cooking utensil P1 is kept constant at a preset heating temperature.

When the preset heating time elapses, the controller 4 stops the heating unit 2 and the heating is completed (step S105). When the heating is completed, the controller 4 transmits the information about the end of heating to the external device 6 via the communicator 5. When the automatic cooking is completed, user input information is received in the application installed on the external device 6 (step S204). The input information is transmitted from the external device 6 to the controller 4 via the communicator 5. The input information is, for example, the cooking result described above. Alternatively, the cooking mode may be input as input information. Alternatively, the heating temperature itself may be input as input information.

The controller 4 creates update information about the heating condition based on the input information entered by the user (step S106). In the embodiment, the update information about the heating condition indicates the amount of change to the preset heating condition, that is, the amount of change in the heating temperature and the heating time, based on the input information entered by the user in step S204. In the embodiment, for example, when the input information is the predetermined input information, update information about at least the heating temperature among the heating conditions is created based on the predetermined input information. The predetermined input information is, for example, information corresponding to the cooking result, or the heating time.

For example, a case where the input information entered by the user is the cooking result will be described. In the application of the external device 6, when the user selects the cooking result of “half-bake” (press one of the cooking result buttons 31 in FIG. 3) and presses the confirmation button 32, the information is transmitted to the controller 4 via the communicator 5.

When the controller 4 receives the input information, the controller 4 creates update information about the heating condition corresponding to the cooking menu and the cooking mode selected in steps S101 and S102. Since the input information is the cooking result of “HALF-BAKED”, update information such as “heating temperature+5° C., heating time+1 minute” is created. The update information may include at least information about the heating temperature. Alternatively, information about heating temperature and heating time may be included.

In addition, the learning unit 14 of the controller 4 accumulates user input information, and the update information may be corrected based on the accumulated input information. The correction of the update information can be created based on, for example, the average value of the number of times of inputs of the accumulated input information (cooking result). The controller 4 may be configured to change the heating condition based on the corrected update information.

The learning unit 14 may be configured to determine the update information about the heating condition by, for example, using a reinforcement learning model for user input information. For example, when the user repeatedly inputs the cooking result each time cooking is performed, the learning unit 14 can learn the optimum heating condition for the cooking menu and the cooking mode by using the reinforcement learning model. As a result, the heating condition when the user selects the cooking menu and the cooking mode can be updated so that the user's favorite cooking result can be obtained.

When the update information is created, the controller 4 updates the heating condition or newly sets the heating condition corresponding to the cooking menu and the cooking mode based on the update information (step S107). Updating the heating condition includes, for example, overwriting the update information about “heating temperature+5° C., heating temperature+1 minute” on the heating condition corresponding to the selected cooking menu and the selected cooking mode. The new setting of heating condition includes setting, as a new menu, the heating condition that reflects the above update information instead of changing the heating condition of the selected cooking menu and the selected cooking mode.

When the controller 4 updates or newly sets the heating condition, the automatic cooking ends.

[Effects]

According to the above-described embodiment, it is possible to provide a heating cooker with improved user convenience. The controller 4 of the present embodiment is configured to receive input information associated with the heating temperature (that is, “predetermined input information” of the present disclosure). Such input information is, for example, a cooking result. Based on the user input information for the cooking result, the controller creates update information about at least the heating temperature among the heating conditions. Therefore, the user can automatically select an appropriate heating condition based on the update information. Also, since at least the heating temperature is used as the heating condition, the heating temperature of the cooking object can be kept constant, so that the cooking result desired by the user can be easily obtained.

Since the controller 4 is connected to the external device 6 via the communicator 5, the user can operate the external device 6 to enter input information. For this reason, according to the embodiment, input information includes the cooking result or the cooking mode, etc., and it is possible to update the heating condition so as to be closer to the cooking result desired by the user.

Further, since the controller 4 has the learning unit 14, it is possible to change the heating condition and/or set a new heating condition by reflecting the user's preferences.

In addition, in the embodiment, an example in which the controller 4 creates the update information based on the input information (step S106), and the heating condition is updated or newly set based on the update information (step S107) is described. The step of updating or newly setting the heating condition in step S107 is not mandatory. The controller 4 may create update information and the automatic cooking may end.

Further, in the present embodiment, although the heating cooker 1 having the three heating units 2 and the cooking chamber 16 is described, the cooking chamber 16 is not an essential configuration. One or more heating coils should be provided.

Further, the operation screen 30 of the external device 6 is not limited to the example described in FIG. 3.

The automatic cooking flow of FIG. 4 is also applicable to, for example, cooking using a grill.

### Second Embodiment

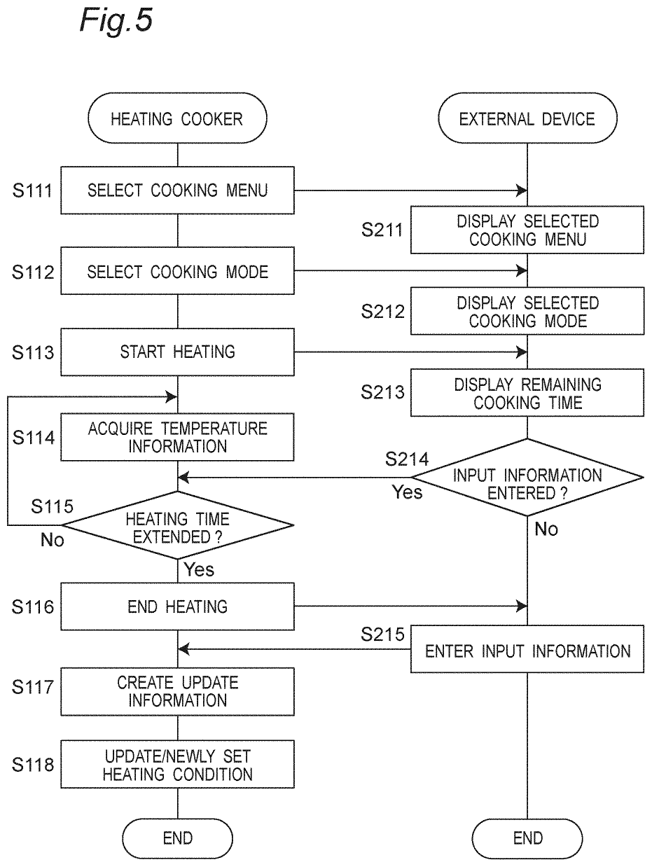

The second embodiment will be described with reference to FIGS. 2 and 5. In the second embodiment, the same or equivalent configurations as those in the first embodiment will be described with the same reference numerals. Further, in the second embodiment, the description overlapping with the first embodiment is omitted.

FIG. 5 is a flowchart showing an example of a cooking operation according to the second embodiment of the heating cooker 1 of FIG. 1.

In the second embodiment, an example of performing automatic cooking using the grill (cooking chamber 16) will be described. As shown in FIG. 2, the food material 19 is placed on the cooking plate 17 disposed inside the cooking chamber 16. The food material 19 is heated by an upper heating body 18a disposed at the upper part of the cooking chamber 16 and a lower heating body 18b disposed at the lower part of the cooking chamber 16. The upper heating body 18a is, for example, a sheath heater, a Milacron heater, a Corche heater, or the like. The lower heating body 18b is, for example, a heating coil. In addition, when cooking is performed using a grill as in the embodiment, the food material 19 corresponds to a “cooking object” of this disclosure, and the upper heating body 18a and the lower heating body 18b correspond to a “heating unit” of the present disclosure.

The cooking chamber 16 has an open front formed in a substantially box shape. An exhaust stack 20 for exhausting smoke or the like generated in the cooking chamber 16 is connected to the rear of the cooking chamber 16. In the present embodiment, the exhaust stack 20 is provided with a temperature detector 3b that detects the temperature inside the cooking chamber 16. The temperature detector 3b is, for example, a thermistor or an infrared sensor.

Next, the operation of automatic cooking in the cooking chamber 16 will be described with reference to FIG. 5.

Steps S111 to S113 of the heating cooker in FIG. 5 are the same as steps S101 to S103 of the first embodiment. Further, steps S211 to S213 of the external device in FIG. 5 are the same as steps S201 to 203 of the first embodiment. Therefore, these explanations will be omitted.

When heating is started by the controller 4 (step S113), the temperature information in the cooking chamber 16 is acquired by measuring the temperature inside the cooking chamber 16 using the temperature detector 3b (step S114). When the acquired temperature information is different from the preset heating temperature, the controller 4 adjusts the outputs of the upper heating body 18a and the lower heating body 18b.

Further, in the present embodiment, before the end of automatic cooking, the application of the external device 6 receives the input information from the user (step S214). For example, the user can input extension of the heating time as input information according to the remaining cooking time displayed on the external device 6 and the state of the food material being cooked (for example, baking color and the like). The input information that can be input in step S214 is not limited to the extension of the heating time, but also includes, for example, the heating temperature and the like as input information.

When the input information is input in step S214, and is transmitted from the external device 6 to the controller 4 via the communicator 5 (Yes in step S214), the controller 4 determines whether it is required to extend the heating time (step S115). The determination of whether it is required to extend the heating time will be implemented based on, for example, whether the extension of heating time was input as input information in step S214. When it is determined that it is required to extend the heating time (Yes in step S115), the process returns to step S114. The extended heating time is determined based on the input information. When it is determined that it is not required to extend the heating time (No in step S115), and the preset heating time elapses, the controller 4 stops the upper heating body 18a and the lower heating body 18b, and the heating is completed (step S116).

When the heating is completed, the application of the external device 6 receives the input information from the user (step S215). The input information after the end of automatic cooking is, for example, a cooking result or a cooking mode, as in the case of the first embodiment. The input information may be received either one of during the execution of automatic cooking (step S214) or after the end of automatic cooking (step S215). In the embodiment, the input information includes information about at least the heating time and the heating temperature. The input information input in step S215 is transmitted from the external device 6 to the controller 4 via the communicator 5.

The controller 4 creates, based on the input information input in steps S214 and S215, update information about the heating condition corresponding to the selected cooking menu and the selected cooking mode (step S117). When the update information is created, the controller 4 updates or newly sets the heating condition corresponding to the cooking menu and the cooking mode based on the update information (step S118).

When the controller 4 updates or newly sets the heating condition, the automatic cooking ends.

[Effects]

According to the above-described embodiment, the heating condition of the automatic cooking currently being performed can be changed. Therefore, the cooking result desired by the user can be easily obtained, and the usability is improved. Also, based on the input information during or after the execution of automatic cooking, the update information about the heating condition is created and the heating condition is updated or newly set. For this reason, when the user selects the same cooking menu and the same cooking mode the next time, the automatic cooking can be performed under the heating condition that reflects the current cooking result and/or the previous cooking result. As a result, the cooking result desired by the user can be easily obtained.

In addition, in the embodiment, a case in which cooking is performed using the grill is explained, but the flow of the automatic cooking in FIG. 5 is also applicable, for example, when cooking is performed using the heating unit 2.

### Third Embodiment

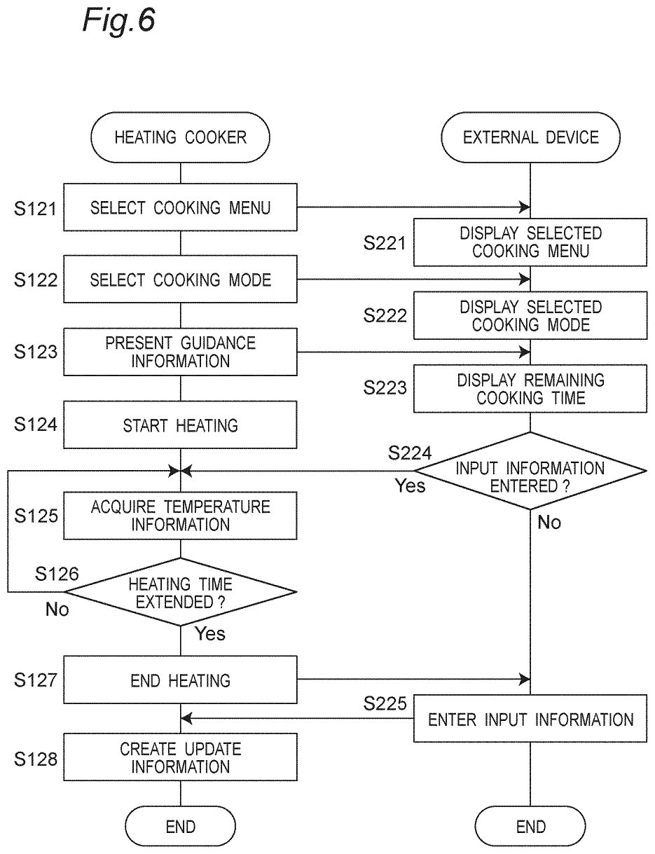

The third embodiment will be described with reference to FIG. 6. In the third embodiment, the configuration different from that of the second embodiment is explained, and the same or equivalent configuration as that of the second embodiment will be described with the same reference numerals. Further, in the third embodiment, the description overlapping with the second embodiment is omitted.

FIG. 6 is a flowchart showing an example of a cooking operation according to the third embodiment of the heating cooker 1 of FIG. 1.

As in the second embodiment, the automatic cooking is performed using the cooking chamber 16 in the third embodiment, but the third embodiment differs from the second embodiment in that the cooking guidance information is presented to the user before the start of the automatic cooking.

Steps S121 to S122 of the heating cooker in FIG. 6 are the same as steps S111 to S112 of the second embodiment. Further, steps S124 to S128 are the same as steps S113 to S117 of the second embodiment. Further, steps S221 to S225 of the external device in FIG. 6 are the same as steps S211 to S215 of the second embodiment. Therefore, these explanations will be omitted.

In the embodiment, when the cooking menu and the cooking mode are selected (steps S121 to S122), the cooking guidance information is presented on the display 15b of the operation unit 15 (step S123). The controller 4 creates guidance information based on the update information at the time of the previous automatic cooking before the automatic cooking is started. The guidance information is information about cooking presented to the user. In the previous automatic cooking, for example, when the update information “heating temperature+2° C.” is created, the controller 4 stores the guidance information based on the update information in the storage 12. When the same cooking menu and the same cooking mode is selected during the next automatic cooking, the controller 4 reads out the guidance information stored in the storage 12, and displays on the display 15b the content stating that “Do you want raise the heating temperature by 2° C.?”. The guidance information may include update information about at least the heating temperature. In addition, the guidance information may include update information about both the heating temperature and the heating time.

[Effects]

According to the embodiment described above, when the cooking menu and the cooking mode are selected without changing the preset heating condition, it is possible to present the update information at the time of the previous automatic cooking to the user as guidance information. The user can select whether to change the heating condition based on the presented guidance information. Since the user can select whether to change the heating condition each time the user performs cooking instead of updating the heating condition by the controller 4, usability is improved.

In addition, in the embodiment, a case in which cooking is performed using the grill is explained, but the flow of the automatic cooking in FIG. 5 is also applicable, for example, when cooking is performed using the heating unit 2.

### EXAMPLE

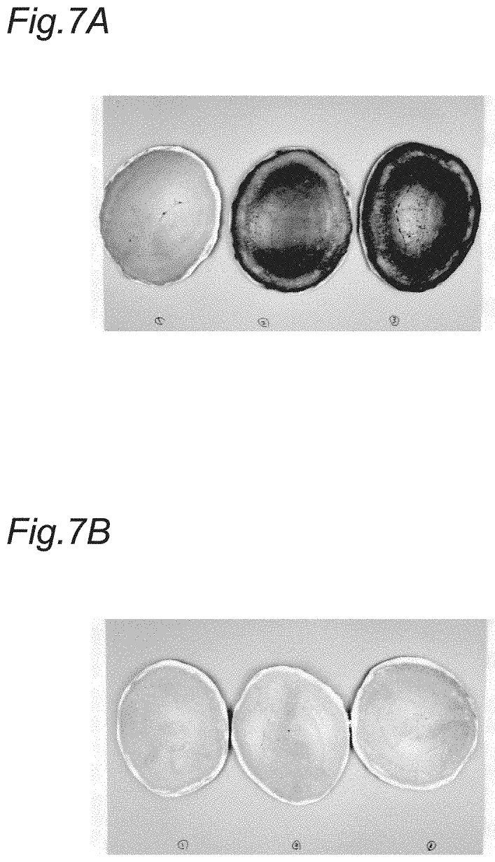

With reference to FIGS. 7A and 7B, cooking results are compared between Comparative Example and Example using the heating cooker of the present disclosure. FIG. 7A is a diagram showing the cooking result of Comparative Example 1. FIG. 7B is a diagram showing the cooking result of Example 1.

### Comparative Example 1

FIG. 7A shows the cooking result when three hot cakes each with a diameter of about 15 cm are consecutively baked in the heating time in which they are heated with a heating power of 500 W and with the front heated for 6 minutes and the back heated for 2 minutes in an induction heating cooker of Comparative Example. The results of the first, second, and third time cooking are shown in order from the left side of FIG. 7A. In the case of Comparative Example 1, the heating power (500 W) and the heating time (6 minutes on the front and 2 minutes on the back) are set as the heating condition. As shown in FIG. 7A, it can be seen that the baking color of the hot cake is darker as the baking is repeated with the second time baking and third time baking. This is because when the heating power is set as the heating condition, as the baking is repeated, or as the cooking time is long, the temperature will rise and it is difficult to obtain the desired cooking result.

### Example 1

FIG. 7B shows the cooking results when the same three hot cakes as in FIG. 7A are consecutively baked in the heating cooker 1 of the present disclosure with some of the heating conditions changed. The results of the first, second, and third time cooking are shown in order from the left side of FIG. 7B. In Example 1, among the heating conditions shown in FIG. 7A, the “heating temperature of 160° C.” is set instead of the “heating power of 500 W”. Other conditions are the same as those in Comparative Example 1. A temperature sensor is disposed in the heating cooker 1 in order to keep the heating temperature constant during cooking, and the bottom face temperature of the cooking utensil (in the case of Example 1, frying pan) can be detected. Due to fluctuations in the bottom face temperature during cooking, the controller 4 of the heating cooker 1 adjusts the heating power.

As in Example 1, when the heating temperature instead of the heating power is used as the heating condition, all three hot cakes which were consecutively baked had a uniform baking color. Therefore, when the heating temperature instead of the heating power is used as the heating condition, it can be seen that the cooking result desired by the user can be easily obtained by using the preset heating condition.

Although the invention of the present disclosure is described above with reference to the above-described embodiments, the invention of the present disclosure is not limited to the above-described embodiments.

For example, in the above-described embodiments, the case where the heating cooker 1 is an induction heating cooker having a heating coil has been described. The heating cooker 1 may be any device such as a gas range, a microwave oven, an electric rice cooker, or the like that heats cooking object under predetermined heating condition.

Further, in the above-described embodiments, an example in which the communicator 5 communicates with an external device via wireless LAN has been explained. The communicator 5 and the external device 6 may communicate with each other by, for example, wireless communication standards such as Bluetooth (registered trademark), Wi-Fi (registered trademark), NFC, and infrared rays.

Further, in the above-described embodiments, an example in which the selected cooking menu, the selected cooking mode, and the remaining cooking time are displayed on the external device 6 has been described. They may be displayed on the heating cooker 1. For example, they can be displayed on the display 15b of the operation unit 15 or can be guided by voice.

Further, in the above-described embodiments, an example in which the cooking guidance information is presented on the display 15b of the heating cooker 1 has been explained. The application of the external device may present it.

Further, in the above-mentioned flowchart of automatic cooking, the processing steps are not limited. For example, the number of steps may be increased or decreased, and the steps can be divided or integrated.

### INDUSTRIAL APPLICABILITY

The present disclosure can be widely applied to a heating cooker that heats a cooking object.

### REFERENCE SIGNS LIST

1 heating cooker

2 heating unit

3a,3b temperature detector

4 controller

5 communicator

6 external device

14 learning unit

15b display (presentation unit)

1. A heating cooker comprising:
a heating unit that heats a cooking object;
a temperature detector that detects temperature information about the cooking object;
a controller that controls the heating unit based on heating conditions including at least a heating temperature and a heating time, and the temperature information; and
a communicator that communicates with an external device, wherein the external device receives input information from a user, wherein
the communicator transmits the input information received from the external device to the controller, and
the controller creates, when the input information is predetermined input information, update information about at least the heating temperature among the heating conditions based on the predetermined input information.

2. The heating cooker according to claim 1, wherein the external device receives the input information after cooking is completed, and the controller changes the heating conditions based on the update information.

3. The heating cooker according to claim 1, wherein the input information includes a cooking result of the cooking object.

4. The heating cooker according to claim 1, wherein the input information includes a cooking mode.

5. The heating cooker according to claim 1, wherein the heating cooker is an induction heating cooker.

6. The heating cooker according to claim 1, wherein
the controller further includes a learning unit that accumulates the input information and corrects the update information based on the accumulated input information, and
the controller changes the heating conditions based on the update information corrected by the learning unit.

7. The heating cooker according to claim 1, wherein
the external device receives the input information during and/or after performing cooking, and
the controller creates the update information about the heating temperature and the heating time among the heating conditions.

8. The heating cooker according to claim 7, wherein the input information includes information about a heating time.

9. The heating cooker according to claim 1, wherein before performing cooking, the controller creates cooking guidance information presented to a user based on the update information when performing cooking last time.

10. The heating cooker according to claim 9, further comprising a presentation unit that presents the guidance information.

11. The heating cooker according to claim 2, wherein the input information includes a cooking result of cooking object.

12. The heating cooker according to claim 2, wherein the input information includes a cooking mode.

13. The heating cooker according to claim 3, wherein the input information includes a cooking mode.

14. The heating cooker according to claim 2, wherein
the controller further includes a learning unit that accumulates the input information and corrects the update information based on the accumulated input information, and
the controller changes the heating conditions based on the update information corrected by the learning unit.

15. The heating cooker according to claim 3, wherein
the controller further includes a learning unit that accumulates the input information and corrects the update information based on the accumulated input information, and
the controller changes the heating conditions based on the update information corrected by the learning unit.

16. The heating cooker according to claim 4, wherein
the controller further includes a learning unit that accumulates the input information and corrects the update information based on the accumulated input information, and
the controller changes the heating conditions based on the update information corrected by the learning unit.

17. The heating cooker according to claim 5, wherein
the controller further includes a learning unit that accumulates the input information and corrects the update information based on the accumulated input information, and
the controller changes the heating conditions based on the update information corrected by the learning unit.

18. The heating cooker according to claim 2, wherein the heating cooker includes an induction heating cooker.

19. The heating cooker according to claim 3, wherein the heating cooker includes an induction heating cooker.

20. The heating cooker according to claim 4, wherein the heating cooker includes an induction heating cooker.
